(19) United States
(12) Patent Application Publication
(10) Pub. No.: US 2025/0084893 A1
(43) Pub. Date: Mar. 13, 2025

(54) SNAP-LOCK SUCTION CUP HOOK

(71) Applicant: Yongxian HU, Guangzhou (CN)

(72) Inventor: Yongxian HU, Guangzhou (CN)

(21) Appl. No.: 18/399,788

(22) Filed: Dec. 29, 2023

(30) Foreign Application Priority Data
Sep. 7, 2023 (CN) 2023224280333

(51) Int. Cl. F16B 47/00; F16M 13/02

(52) U.S. Cl. CPC F16B 47/00; F16M 13/022

(57) ABSTRACT

The present invention discloses a snap-lock suction cup hook, including an inner shell and an outer shell, wherein a plurality of grooves are formed in the periphery of the inner shell; clamping slots are formed in the bottoms of the grooves; a plurality of protruding snaps are disposed on the inner wall surface of the outer shell; the outer shell is sleeved on the outer side of the inner shell; the snaps are disposed in the grooves and fall along the grooves into the clamping slots in the end portions thereof, such that the outer shell and the inner shell are connected by clamping. The outer shell fits tightly with the inner shell through the snaps and the clamping slots, thereby replacing the traditional technology of bonding with glue, providing more secure fitting without being affected by the weather, and prolonging the service life.

### CROSS-REFERENCE TO RELATED APPLICATIONS

The application claims priority to Chinese patent application No. 2023224280333, filed on Sep. 7, 2023, the entire contents of which are incorporated herein by reference.

### TECHNICAL FIELD

The present invention relates to the field of suction cups, and in particular, to a snap-lock suction cup hook.

### BACKGROUND

The outer metal shells of existing suction cup type hanging tools are fitted with the inner plastic shells thereof by bonding with glue. The glue will become brittle and loose its effectiveness after long time of bonding, and even more prone to poor bonding effect and short service life in a cold winter.

### SUMMARY

The present invention aims at solving the problem of poor structural stability of connection between existing outer metal shells and inner plastic shells.

The technical solution of the present invention is as follows: a snap-lock suction cup hook, including an inner shell and an outer shell, wherein a plurality of grooves are formed in the periphery of the inner shell; clamping slots are formed in the bottoms of the grooves; a plurality of protruding snaps are disposed on the inner wall surface of the outer shell; the outer shell is sleeved on the outer side of the inner shell; the snaps are disposed in the grooves and fall along the grooves into the clamping slots in the end portions thereof, such that the outer shell and the inner shell are connected by clamping.

Compared with the prior art, the present invention has the following beneficial effects: the outer shell fits tightly with the inner shell through the snaps and the clamping slots, thereby replacing the traditional technology of bonding with glue, providing more secure fitting without being affected by the weather, and prolonging the service life.

### BRIEF DESCRIPTION OF DRAWINGS

FIG. 1 is a front view of the present invention;

FIG. 2 is an exploded view of the present invention;

FIG. 3 is a schematic structural diagram of clamping connection between an outer shell and an inner shell of the present invention;

FIG. 4 is a schematic structural diagram of detachment between an inner shell and a rotating shaft of the present invention; and

FIG. 5 is a schematic structural diagram of fixed connection between a base plate and a rotating shaft of the present invention.

Reference numerals: inner shell 10; outer shell 20; groove 11; clamping slot 12; snap 21; stainless steel hook 22; base plate 13; mounting cavity 14; rotating shaft 30; side wall 15; connecting rod 31; positioning groove 16; bottom gasket 17.

### DETAILED DESCRIPTION OF THE EMBODIMENTS

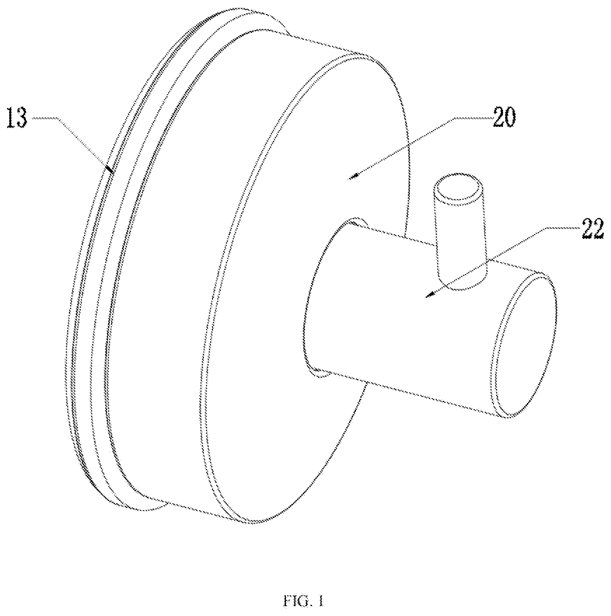

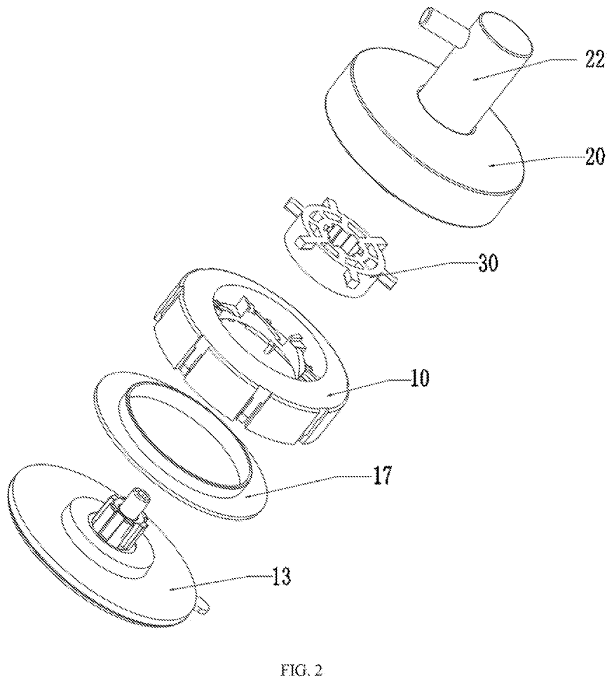

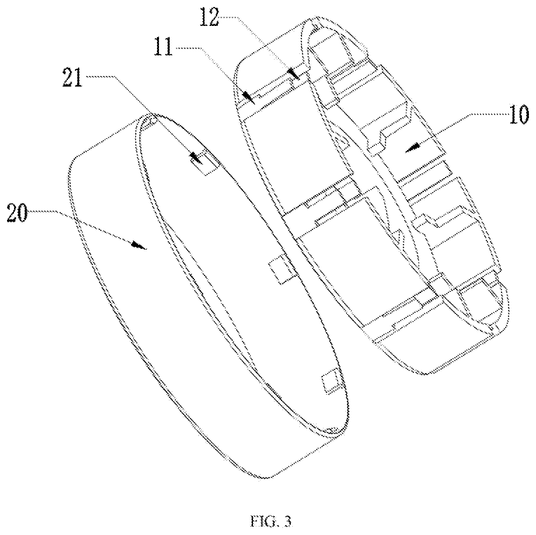

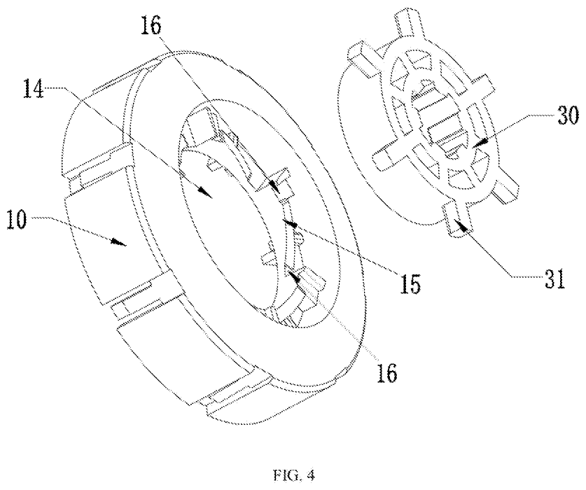

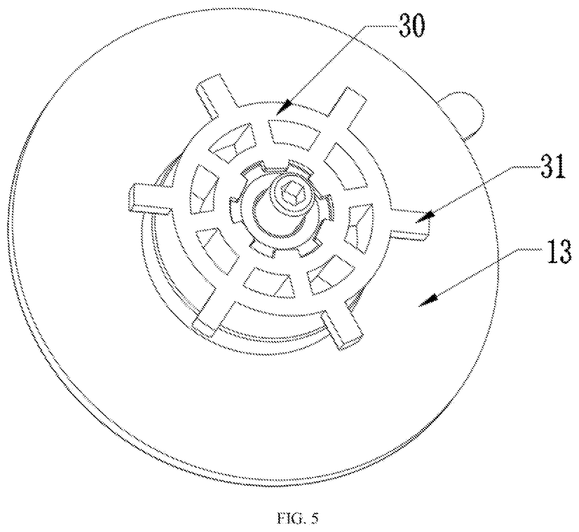

As shown in FIGS. 1-5, a snap-lock suction cup hook includes an inner plastic shell 10 and an outer stainless steel shell 20, wherein a plurality of grooves 11 are formed in the periphery of the inner shell 10; a clamping slot 12 is formed in one end of the bottom of each of the grooves 11; a plurality of protruding reversely-folded snaps 21 are disposed on the inner wall surface of the outer shell 20; the outer shell 20 is sleeved on the outer side of the inner shell 10; the snaps 21 are disposed in the grooves 11 and fall along the grooves 11 into the clamping slots 12 in the end portions thereof by pressing the outer shell 20, such that the outer shell 20 fits tightly with the inner shell 10 through the snaps 21 and the clamping slots 12, thereby replacing the traditional technology of bonding with glue, providing more secure fitting without being affected by the weather, and prolonging the service life.

A stainless steel hook 22 is disposed in the outer shell 20, which can hang an object in use.

A base plate 13 is disposed at the other side of the inner shell 10 far away from the outer shell 20; a mounting cavity 14 is formed in the inner shell 10; a rotating shaft 30 is disposed in the mounting cavity 14; one end of the base plate 13 extends into the rotating shaft 30 and is fixedly connected thereto; a plurality of gradually-protruding side walls 15 are disposed at the edge of the mounting cavity 14; positioning grooves 16 are formed in both the tops and the bottoms of the side walls 15; a plurality of connecting rods 31 are disposed on the periphery of the rotating shaft 30; and the connecting rods 31 are disposed on the upper surfaces of the side walls 15 and move up and down therein.

When the suction cup hook needs to be fixedly mounted on the surface of a wall, the outer shell 20 is rotated and drives the inner shell 10 to rotate; the inner shell 10 propels the connecting rods 31 through the gradually-protruding side walls 15 to move from the bottoms to the tops of the side walls and finally fall into the positioning grooves 16; and at this time, the suction cup hook is fixedly mounted on the surface of the wall and an object needing to be hung can be hung on the surface of the wall through the stainless steel hook 22.

When the suction cup hook needs to be detached from the wall, the outer shell 20 is rotated and drives the inner shell 10 to rotate, such that the connecting rods 31 are moved to the positioning grooves 16 in the bottoms of the side walls 15 from the positioning grooves 16 in the tops of the side walls 15; and at this time, the suction cup book can be detached from the wall and relocated.

A bottom gasket 17 is disposed between the base plate 13 and the inner shell 10.

What is claimed is:

1. A snap-lock suction cup hook, comprising an inner shell (10) and an outer shell (20), wherein a plurality of grooves (11) are formed in the periphery of the inner shell (10); clamping slots (12) are formed in the bottoms of the grooves (11); a plurality of protruding snaps (21) are disposed on the inner wall surface of the outer shell (20); the outer shell (20) is sleeved on the outer side of the inner shell (10); the snaps (21) are disposed in the grooves (11) and fall along the grooves (11) into the clamping slots (12) in the end portions thereof, such that the outer shell (20) and the inner shell (10) are connected by clamping.

2. The snap-lock suction cup hook according to claim 1, wherein a base plate (13) is disposed at one side of the inner shell (10); a mounting cavity (14) is formed in the inner shell (10); a rotating shaft (30) is disposed in the mounting cavity (14); one end of the base plate (13) extends into the rotating shaft (30) and is fixedly connected thereto; a plurality of gradually-protruding side walls (15) are disposed at the edge of the mounting cavity (14); a plurality of connecting rods (31) are disposed on the periphery of the rotating shaft (30); and the connecting rods (31) are disposed on the upper surfaces of the side walls (15) and move up and down therein.

3. The snap-lock suction cup hook according to claim 2, wherein positioning grooves (16) are formed in both the tops and the bottoms of the side walls (15).

4. The snap-lock suction cup hook according to claim 1, wherein the snaps (21) are provided in a reversely-folded structure.

5. The snap-lock suction cup hook according to claim 1, wherein the inner shell (10) is made of a plastic material.

6. The snap-lock suction cup hook according to claim 1, wherein the outer shell (20) is made of a stainless steel material.

7. The snap-lock suction cup hook according to claim 2, wherein a bottom gasket (17) is disposed between the base plate (13) and the inner shell (10).
